(19) United States
(12) Patent Application Publication
(10) Pub. No.: US 2025/0348937 A1
(43) Pub. Date: Nov. 13, 2025

(54) Electronic Proxy Voting Systems and Methods

(71) Applicant: PROXYMITY LIMITED, London (GB)

(72) Inventors: Dean Little, Stansted (GB); Jonathan Smalley, London (GB)

(21) Appl. No.: 19/218,176

(22) Filed: May 23, 2025

Related U.S. Application Data
(63) Continuation-in-part of application No. 16/050,279, filed on Jul. 31, 2018, now abandoned.
(60) Provisional application No. 62/539,164, filed on Jul. 31, 2017.

(51) Int. Cl. G06Q 40/04

(52) U.S. Cl. CPC G06Q 40/043

(57) ABSTRACT

Systems and methods involve an intelligent application mapping function of a central platform that maps a direct interactive electronic communication channel between an issuer terminal and an investor terminal based at least partly on investor positions in the issuer held by respective custodial intermediaries in a chain of custodial intermediaries for the investor. Thereafter, an intelligent application notification function of the platform transmits, via the direct interactive electronic communication channel to the investor terminal, data representing a notification regarding a meeting for the issuer, and an intelligent application voting function of the platform returns, from the investor terminal via the direct interactive electronic communication channel to the processor of the issuer terminal, data representing an exercise of investor voting rights associated with the investor positions for the investor.

### CROSS REFERENCE TO RELATED APPLICATIONS

This application is a continuation-in-part of U.S. patent application Ser. No. 16/050,279 filed Jul. 31, 2018, entitled “Electronic Proxy Voting Systems and Methods” which claims the benefit of priority to U.S. Provisional Application No. 62/539,164 filed Jul. 31, 2017, entitled “Electronic Proxy Voting Systems and Methods”. The entire contents of each of the above-referenced applications are hereby incorporated by reference in their entirety.

### FIELD OF THE INVENTION

The present invention relates generally to the field of electronic proxy voting platforms, and more particularly to systems and methods for electronically partitioning and layering custody and other financial intermediary account and position data for direct interactive electronic communication of proxy voting-related data between issuers and investors.

### BACKGROUND OF THE INVENTION

Typically, equity and debt securities of an issuer may be held indirectly on behalf of investors, such as institutional investors, through financial service providers, referred to herein as custodians or custodial intermediaries. Currently, such securities may normally be held on behalf of investors through chains of custodians that are connected through a chain of contractual links that are independent from one another. Thus, an investor may enter a contract with a first custodian, who may enter a contract with one or more other custodians, who may likewise enter further contracts with still other custodians. Each such contract is independent of the contract between the investor and the first custodian, and the investor has limited control over who or how many such additional custodians are in the custodial chain.

Proxy voting allows investors to vote without the necessity of attending shareholder meetings, such as annual meetings or extraordinary general meetings of shareholders. The current process of proxy voting by investors is characterized by the chain of custodian-intermediaries that makes it very difficult for an issuer who plans to convene such a shareholder meeting to announce the meeting, for example, to their institutional investors and for those institutional investors to vote their shares.

The voting process may start with the issuer planning to convene a meeting and, for example, providing meeting materials to the issuer's appointed agent. The issuer's agent may be an entity that represents the issuer, for example, in selling and distributing securities to investors. The issuer's agent may then publicly announce the meeting through various forms of media including, for example, physically mailing meeting materials to shareholders that appear on a register of current shareholders, mailing the meeting materials to sub-custodian banks, and in some markets, announcing the meeting on an electronic platform that may be provided by a central securities depositary in certain markets.

A sub-custodian may be an institution, such as a bank, that provides custody services with respect to securities traded in a particular market or jurisdiction on behalf of another custodian who may not have an operation or office in that market or jurisdiction. The sub-custodians who receive those announcements may then commence the coding of an electronic version of the meeting agenda, including the items which are intended to be voted upon at the meeting. The sub-custodians may then seek to send that electronic version of the meeting agenda as an electronic message, such as an ISO15022 SWIFT format MT 564 message, to their contractual counterparts in the chain of custody, which may include broker-dealers as well as global custodians.

A global custodian may be an institution that holds securities for investors in a central place by maintaining a contractual relationship with a network of sub-custodians and/or other global custodians. Traditionally, global custodians service buy-side institutions, for example and without limitation, wealth managers, fund managers and sovereign wealth funds. Global custodians generally dislike this type of electronic messaging process because important information about the meeting, such as the items to be voted upon, are included in the message in a free-format text block, and as such, the global custodians cannot systemically and in a automated manner read those messages and code them into their internal platforms and announce the meeting information onward to their clients.

Thus, global custodians may be required to rely on multiple outsourced proxy voting specialist service providers as their only resource. Such a proxy voting specialist provider may, for example, collate all meeting announcements received by the global custodian from various sub-custodians for a particular meeting and attempt to create a single record of the meeting. The specialist provider may then use the outsourced information delivered by the custodian services to announce the meeting on behalf of the global custodian to the global custodian's clients, many of whom may likely be institutional investors or entities who have institutional investors.

It is self-apparent that the current process by which an institutional investor receives notice of a meeting to be convened by an issuer may involve manual handling of the meeting information by at least three or more intermediaries during the process. For example, at a minimum such intermediaries may include at least a sub-custodian, a global custodian, and the global custodian's outsourced proxy voting specialist service provider. The current process results in delaying receipt of the meeting notice by investors which in turn results in delaying commencement of deliberations by the investors on how they may vote and in providing their voting instructions to the proxy voting specialist provider.

Once the proxy voting specialist service provider receives those voting instructions, the service provider must deliver the voting instructions into a chain of custody either to a sub-custodian or back towards a global custodian for onward delivery into the market. The voting instructions are likewise typically included in a free format text block of an electronic message, such as an ISO15022 SWIFT MT565 message, when they are sent back into the layer of sub-custodians and therefore cannot be systemically processed and as a result require manual handling. Therefore, a sub-custodian, for example, in a developing market must typically print out the instructions and vote locally in the market in accordance with local market requirements, such as by email to the issuer or the issuer agent, manually logging onto a terminal provided by a central securities depository, or in some cases by physical representation at the place at which the meeting is being convened.

Thus, the current process in which a chain of intermediaries handles the meeting information results in delaying receipt by investors of the meeting information. Further, because the meeting information must be taken from a physical source and coded onto an electronic medium in a free format text block, the information is often corrupted. Moreover, there may likely be different versions of the agenda, which in many cases may confuse institutional investors about what the meeting agenda actually represents and what will be voted upon at the meeting.

Finally, once an investor provides voting instructions into a chain of custody, it may take many days to reach the issuer because of the many different entities involved in the current process. Issuers may therefore receive votes sent by such institutions only hours before the meeting and therefore may have very little time to engage investors if they either believe a vote has been instructed incorrectly or wish to engage in dialogue to allay investor fears. In many cases, because of the chain of intermediaries and involvement of nominee companies, issuers may have no idea which investor has instructed which vote and must therefore employ third party firms to attempt to learn that information.

As noted, the proxy voting process may currently be outsourced to proxy voting services specialist providers who may receive meeting information from the issuer. However, such proxy voting specialist providers do not presently use this information, for example, to build a map of the chain of custody in order simplify the process flow for the transmission of the information. Instead, they simply provide a service to the next intermediary in the custodian chain with a hope that such next intermediary will also employ them to perform a similar service under the current proxy voting architecture. As a result, in the existing process, institutional investors are often penalized with an early voting cut-off and no ability to confirm with any degree of certainty that the issuer received their voting instructions. For example, the only actions that an institutional investor may be able to confirm is that it provided its voting instructions to its own contractual custodian and that its own custodian passed along those voting instructions to the next link in the custody chain.

While there are presently a few electronic voting platforms in use in various markets around the world, the only accounts which such platforms typically allow to vote are ones that are directly recognized by the issuer or issuer agent and are of no use to investors who hold investments through a chain of custodians. Thus, engagement by an institutional investor with an issuer is typically not possible because the investor is in many cases at least three or more intermediaries removed from the issuer. Consequently, the existing processes are not transparent to institutional investors beyond the custodian with which they contract, and they can have no confidence that their votes were actually received and counted at a shareholders' meeting.

There is a present need for electronic proxy voting systems and methods that overcome the deficiencies of the above-described legacy systems. The problem that is solved by embodiments of the invention is rooted in technological limitations of the legacy approaches, and improved techniques and, in particular, improved applications of technology are needed to address the problems of such currently employed mechanisms. More specifically, the technologies applied in the aforementioned legacy approaches fail to achieve the sought-after capabilities of the herein-disclosed electronic proxy voting systems and methods.

### SUMMARY OF THE INVENTION

| Embodiments of the invention advance technical fields for addressing problems associated with the above-described legacy processes as well as advancing peripheral technical fields. Such embodiments of the invention employ computer hardware and software, including, without limitation, one or more processors coupled to memory and non-transitory computer-readable storage media with one or more executable programs stored thereon which instruct the processors to perform the mapping and direct interactive electronic communication of proxy voting-related data described herein.

Embodiments of the invention are directed to technological solutions that may involve automated systems that may employ, for example, an intelligent application mapping function of one or more central platform processors coupled to memory that maps a direct interactive electronic communication channel between a processor of a terminal for an issuer and a processor of a terminal for at least one investor based at least in part on data regarding investor positions in the issuer held by respective custodial intermediaries in a chain of custodial intermediaries for at the least one investor; an intelligent application notification function of the one or more central platform processors that transmits, via the direct interactive electronic communication channel to the processor of the terminal for the at least one investor, data representing a notification regarding a meeting for the issuer; and an intelligent application voting function of the one or more central platform processors that returns, from the processor of the terminal for the at least one investor via the direct interactive electronic communication channel to the processor of the terminal for the issuer, data representing an exercise of investor voting rights associated with the investor positions for the at least one investor at the meeting.

In other aspects of embodiments of the invention, the data regarding investor positions in the issuer held by the respective custodial intermediaries in the chain of custodial intermediaries for the at the least one investor may include, for example, data regarding linkages between the respective custodial intermediaries. Additional aspects may involve, for example, the intelligent application mapping function of the one or more central platform processors that receives the data regarding investor positions in the issuer held by the respective custodial intermediaries in the chain of custodial intermediaries for the at the least one investor from processors of terminals of the respective custodial intermediaries.

Still other aspects of embodiments of the invention may involve, for example, the intelligent application mapping function of the one or more central platform processors that recognizes the investor voting rights associated with the investor positions in the issuer based at least in part on said data regarding investor positions held by said respective custodial intermediaries. In additional aspects, the respective custodial intermediaries holding the investor positions in the issuer on behalf of the investor may include, for example, one or more of a global custodial entity, a sub-custodial entity, a wealth manager entity, and a private bank entity.

Further embodiments of the invention may involve, for example, the intelligent application mapping function of the one or more central platform processors that iteratively maps the direct interactive electronic communication channel between the processor of the terminal for the issuer and the processor of the terminal for the at least one investor based at least in part on update data regarding investor positions in the issuer held by the respective custodial intermediaries in the chain of custodial intermediaries for the at least one investor. In still further aspects, the update data regarding investor positions in the issuer held by the respective custodial intermediaries in the chain of custodial intermediaries for the investor may include, for example, update data regarding linkages between the respective custodial intermediaries

Additional aspects of embodiments of the invention may involve, for example, the intelligent application mapping function of the one or more central platform processors that defines the direct interactive electronic communication channel between the processor of the terminal for the issuer and the processor of the terminal for the at least one investor according to an algorithm based at least in part on the data regarding investor positions in the issuer held by the respective custodial intermediaries in the chain of custodial intermediaries for at the least one investor.

Further aspects of embodiments of the invention may involve, for example, the intelligent application notification function of the one or more central platform processors that transmits, via the direct interactive electronic communication channel to the processor of the terminal for the at least one investor, data representing the investor voting rights associated with the investor positions in the issuer exercisable at the meeting. Other aspects may involve, for example, the intelligent application notification function of the one or more central platform processors that recognizes the investor voting rights associated with the investor positions in the issuer. Additional aspects may involve, for example, the intelligent application notification function of the one or more central platform processors that transmits, via the direct interactive electronic communication channel to the processor of the terminal for the at least one investor, the data representing the notification regarding the meeting for the issuer in real time responsive to an upload of information regarding the meeting.

Still other aspects of embodiments of the invention may involve, for example, the intelligent application notification function of the one or more central platform processors that transmits, via the direct interactive electronic communication channel to the processor of the terminal for the at least one investor, the data representing the notification regarding the meeting for the issuer without interpretation by any of said respective custodial intermediaries. Still further aspects may involve, for example, the intelligent application notification function of the one or more central platform processors that transmits, via the direct interactive electronic communication channel to the processor of the terminal for the at least one investor, the data representing the notification regarding the meeting for the issuer a predetermined number days before a date scheduled for the meeting.

Additional aspects of embodiments of the invention may involve, for example, the intelligent application notification function of the one or more central platform processors that transmits, via the direct interactive electronic communication channel to a processor of a terminal of a vote advisory agent for the investor. Other aspects may involve, for example, the intelligent application notification function of the one or more central platform processors that transmits, via the direct interactive electronic communication channel to the processor of the terminal for the at least one investor, the data representing the notification regarding the meeting consisting at least in part of all items slated for voting, market cut-off for voting, and number of exercisable investor voting rights.

Still other aspects of embodiments of the invention may involve, for example, the intelligent application voting function of the one or more central platform processors that recognizes that the data representing the exercise of said investor voting rights is valid and consistent with the investor positions. Further aspects may involve, for example, the intelligent application voting function of the one or more central platform processors that transmits, via the direct interactive electronic communication channel to the processor of the terminal for the at least one investor, data representing post-meeting confirmation of the exercise of the investor voting rights. It is to be understood that the fragmented legacy processes cannot support this functionality, which is made possible, for example, by the layering mechanism in embodiments of the invention. In still further aspects, the one or more central platform processors may include, for example, one or more web-based central platform processors. In still other aspects, the one or more central platform processors may include, for example, one or more web-based central platform processors accessible only by authorized users.

Embodiments of the invention may also provide methods that involve, for example, mapping, by an intelligent application mapping function of one or more central platform processors coupled to memory, a direct interactive electronic communication channel between a processor of a terminal for an issuer and a processor of a terminal for at least one investor based at least in part on data regarding investor positions in the issuer held by respective custodial intermediaries in a chain of custodial intermediaries for at the least one investor; transmitting, by an intelligent application notification function of the one or more central platform processors, via the direct interactive electronic communication channel to the processor of the terminal for the at least one investor, data representing a notification regarding a meeting for the issuer; and returning, by an intelligent application voting function of the one or more central platform processors, from the processor of the terminal for the at least one investor via the direct interactive electronic communication channel to the processor of the terminal for the issuer, data representing an exercise of investor voting rights associated with the investor positions for the at least one investor at the meeting.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that illustrates an overview example of components and flow of information between components of the central platform for embodiments of the invention;

FIGS. 2A and 2B are respective partial views of a schematic diagram that illustrates an overview example of a process of mapping investors to custodial chains and layering the chains of intermediaries for direct interactive communication between an issuer terminal and one or more investors' terminals by the one or more central platform processors for embodiments of the invention;

FIG. 3 is a flow diagram that illustrates an example of a process of mapping and performing direct interactive electronic communication of proxy voting-related data for embodiments of the invention;

FIG. 4 is a flow diagram that further illustrates an example of a process of mapping and a holdings process and holdings service for data ingestion into system tables; and

FIG. 5 is a flow diagram that illustrates an example of a process of genearating a holidngs hierarchy and ballot generation.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention advance the technical fields for addressing problems associated with the above described currently employed complex chain of intermediaries and opaque, inefficient, expensive, and error-prone handling of proxy voting data, as well as advancing peripheral technical fields. The technological solution provided by embodiments of the invention departs from the legacy proxy voting processes which employ such complex chains of intermediaries and handling of information.

Embodiments of the invention provide a central platform application by which custodians, sub-custodians, global custodians, and other custodial intermediaries which have institutional investor clients may upload investor data to the platform over a fixed file format or more dynamic interfaces such as dynamic application programming interfaces or through a network of nodes. In embodiments of the invention, such investor data may comprise account data, position data, and data regarding linkages between investors and intermediaries connected to one another to form a custodial chain. It is to be understood that a position may be defined, for example, as an amount of a particular security, commodity or currency held or owned by a person or entity.

The central platform includes one or more processors that facilitate a direct interactive electronic communication channel between an issuer and an investor, based on data regarding investor positions in the issuer as maintained across a chain of custodian intermediaries. The system operates across a hierarchical mapped structure of custodians and supports interaction by multiple levels of intermediaries.

The platform continuously reconciles investor holdings across all levels of the custodial chain and maintains alignment between issuer records and investor entitlements in real time. It enables multiple levels of intermediaries and investors to access and interact with position-based information, with continuous updates as holdings change.

The system also certifies that an end investor holds shares in each issuer, based on data aggregated from the chain of custody. It establishes a verified connection between issuer and investor holdings, allowing the issuer or authorized entities to identify and confirm beneficial ownership across the intermediary chain.

The platform supports any application that requires real-time verification of share ownership by mapping and maintaining a continuously updated relationship between issuer entities and underlying investors.

The platform for embodiments of the invention may include an intelligent application executing on one or more processors coupled to memory which may employ one or more algorithms to perform a mapping function of building a direct conduit between an issuer and an investor, as will be described below. Further, the platform may iteratively map the conduit between the issuer and the investor on a periodic basis, such as on a daily basis. For example, the one or more platform processors may employ the one or more algorithms to match each investor's positions in an issuer with corresponding voting rights and notify the investor when the relevant issuer announces the meeting. Upon receiving such notification, the investors or their appointed investor agents may then vote directly on the platform.

Thus, the platform for embodiments of the invention provides a complete proxy voting process from issuer through to investor by digitally mapping and authenticating a direct pathway of ownership between an issuer and its investors via which the issuer may announce its meetings to investors directly on the platform. If desired, an appointed issuer agent may support an issuer with an announcement of a meeting and/or the collection of votes from investors via the platform. Investors may review meeting information and input their voting decisions. Similarly, if desired, an appointed voter advisor may support an investor with review of information and input of votes via the platform.

The platform application for embodiments of the intention may be sufficiently intelligent to know that an issuer or its appointed agent has created a meeting on the application so that the meeting information may be input directly to the application. Further, the application may be sufficiently intelligent to know which investor has a position in that issuer and thus has voting rights matched to the investor. In addition the application may inform the investor of all items to be voted upon at the meeting, the market cut-off for voting, and the number of voting rights that the investor has to exercise.

Thus, in embodiments of the invention, the investor has immediate access to information about the meeting as soon as the issuer or the issuer agent uploads the information. The information available and accessed by the investor is uncorrupted by any intermediary because it has been uploaded from the source (the issuer) and transmitted through the platform for embodiments of the invention. Thereafter, for example, when an institutional investor reaches a decision on how the institution wishes to vote on the items announced by the issuer, the application for embodiments of the invention may use the conduit that it created to transmit the investor's vote on the account that the investor holds with its contractual custodian, for example, to the issuer or issuer agent at the other end of the conduit. Thus, the issuer is able to recognize that a download that is received from the platform for embodiments of the invention is a valid vote consistent with positions held by investors within the market. Additionally, the issuer is able to supply a vote confirmation acknowledgement directly to the investor through the platform for embodiments of the invention.

Accordingly, as previously noted, embodiments of the invention advance technical fields for addressing problems associated with the above-described legacy processes as well as advancing peripheral technical fields, for example, by providing direct interactive communication to investors of accurate meeting information instantly, without interpretation by custodial intermediaries, and without impinging on a timeframe for voting cut-off, as well as providing direct interactive communication to issuers from investors of investor votes likewise instantly. Further, the one or more platform processors also provide direct interactive communication to investors of confirmation that their votes were accounted for. It is thus self-apparent that embodiments of the invention eliminate costly and inefficient intermediary processing of legacy processes.

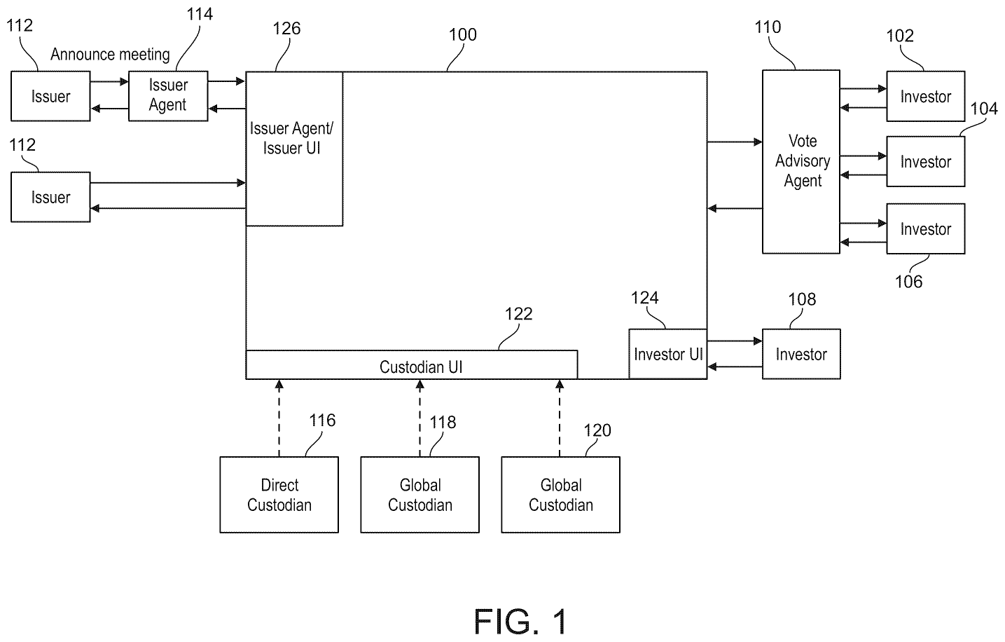

FIG. 1 is a schematic diagram that illustrates an overview example of components and flow of information between components of a platform for embodiments of the invention. Referring to FIG. 1, embodiments of the invention may employ, for example, one or more processors of a central platform 100 executing an intelligent application and accessible via user interfaces, such as custodian user interface 122, investor or investor agent user interface 124, and issuer or issuer agent interface 126.

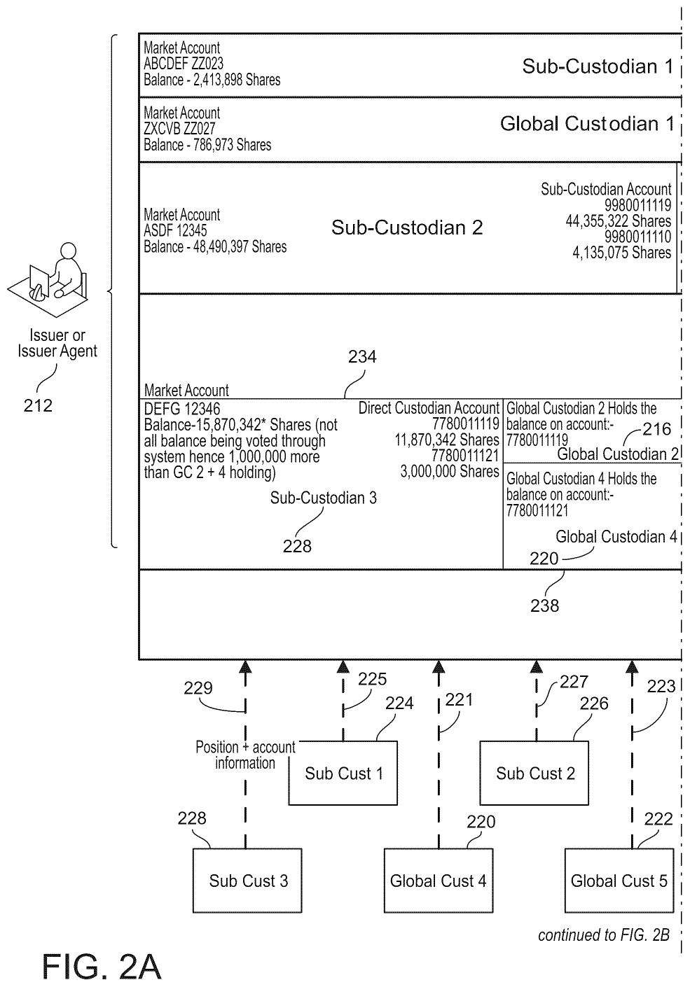

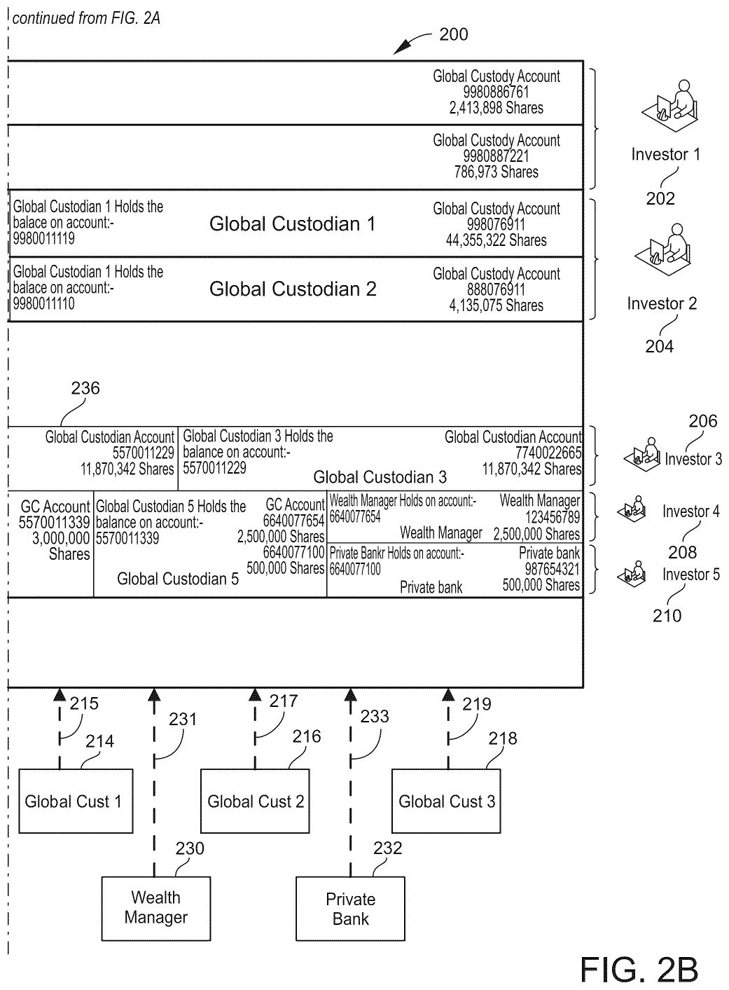

FIGS. 2A and 2B are respective partial views of a schematic diagram that illustrates an overview example of the mapping of investors to custodial chains and layering the chains of intermediaries for direct interactive communication between an issuer and investors by the one or more processors of the central platform 200 executing the intelligent application for embodiments of the invention. Referring to the schematic diagram of FIGS. 2A and 2B, in embodiments of the invention, information may flow, for example, between one or more investors, such as investors 202, 204, 206, 208, and 210, and an issuer or issuer agent 212.

Referring further to the schematic diagram of FIGS. 2A and 2B, each investor's accounts may be represented by account numbers associated with the respective investors, and the schematic diagram of FIGS. 2A and 2B also illustrates examples of information that may be provided internally by the platform application 200 for embodiments of the invention in terms of building a direct pathway of custodial intermediaries between the issuer 212 and the investors, 202, 204, 206, 208, and 210.

Referring again to the schematic diagram of FIGS. 2A and 2B, custodial entities of a custodial chain, may include, without limitation, for example, global custodians 214, 216, 218, 220, and 222, sub-custodians 224, 226, and 228, a wealth manager 230, and a private bank 232. Referring still further to the schematic diagram of FIGS. 2A and 2B, investor information, such as position and account information, may be uploaded to platform 200, for example, by global custodians 214, 216, 218, 220, and 222 at 215, 217, 219, 221, and 223, by sub-custodians 224, 226, and 228 at 225, 227, and 229, by wealth manager 230 at 231, and by private bank 232 at 233.

Based upon the uploaded position and account information, the one or more platform processors 200 executing the intelligent application for embodiments of the invention may employ an algorithm to build the blocks illustrated schematically in the schematic diagram of FIGS. 2A and 2B as extending between the respective investors 202, 204, 206, 208, and 210 and the issuer or issuer agent 212. For example, sub-custodian 228 represented in block 234 may connect to global custodian 216 represented in block 236 and global custodian 220 represented in block 238. Further, the accounts listed in block 234 in which sub-custodian 228 is represented may link to the accounts listed respectively in blocks 236 and 238 in which global custodian 216 and global custodian 220, respectively, are represented. Thus, as noted, the position and account information may be uploaded to platform 200 for each of investors, 202, 204, 206, 208, and 210 by the respective custodial intermediaries.

Referring to FIG. 1, in embodiments of the invention, information may flow, for example, between investors 102, 104, 106, and 108 either direct or via a vote advisory agent 110 and an issuer 112 similarly either direct or via an issuer agent 114. It is to be understood that a meeting may be announced a predetermined number of days in advance of the date scheduled for the meeting, such as 20 days or 21 days before the scheduled meeting date. However, it is to be understood further that a meeting may announced any other suitable number of days in advance of the date scheduled for the meeting. Thus, the issuer 112 or the issuer agent 114 may enter meeting information into the platform 100 for embodiments of the invention the predetermined number of days before the scheduled meeting date.

Referring again to FIG. 1, direct custodian 116, global custodians 118 and 120, in the schematic diagram of FIG. 1 may correspond to one or more of global custodians 214, 216, 218, 220, and 222, sub-custodians 224, 226, and 228, wealth manager 230, and private bank 232 in the schematic diagram of FIGS. 2A and 2B in terms, for example, of uploading information to the platform 100 via the custodian user interface 122 for embodiments of the invention. For example, custodians 116, 118, and 120 may hold positions in the issuer 112 on behalf of contracting clients, such as investors 102, 104, 106, and 108.

Referring further to FIG. 1, investors 102, 104, 106, and 108 are ultimately the rightful beneficial owners of such positions and are entitled to vote those positions as the investors in the custodial chain. In embodiments of the invention, custodians 116, 118, 120 are required to upload the chain of custody to the platform 100. For example, custodians 116, 118, 120 must upload information regarding which positions belong to which account, whereupon the platform 100 for embodiments of the invention may link all of that information together for each particular investor. The result describes the eligibility and the number of shares on which a particular investor is entitled to vote within the platform.

Referring once more to FIG. 1, the investors' votes are cast within the platform 100 and transmitted through the platform for embodiments of the invention direct to the issuer 112. Further, investors such as investor 108 may communicate directly with the platform 100 via an investor user interface 124. Alternatively, investors, such as investors 102, 104, and 106, may communicate with the platform 100 via a vote advisory agent 110. Similarly, an issuer, such as issuer 112 may either communicate directly with the platform 100 at user interface 126 and upload information or may appoint an issuer agent 114 to perform that function on behalf of the issuer to upload the information to the platform.

It is to be understood that aspects of the schematic diagram of FIG. 1 and the schematic diagram of FIGS. 2A and 2B generally correspond to one another. For example, the diagram of FIG. 1 shows an example of the flow of information between the elements of a system for embodiments of the invention, and the schematic diagram of FIGS. 2A and 2B shows an example of custody chains between an issuer and investors. Thus, the diagram of FIG. 1 illustrates a high-level flow of information and the access points within the platform for embodiments of the invention, and the schematic diagram of FIGS. 2A and 2B illustrates example details showing the manner in which the platform becomes the direct path of custody from a custodian through to an investor.

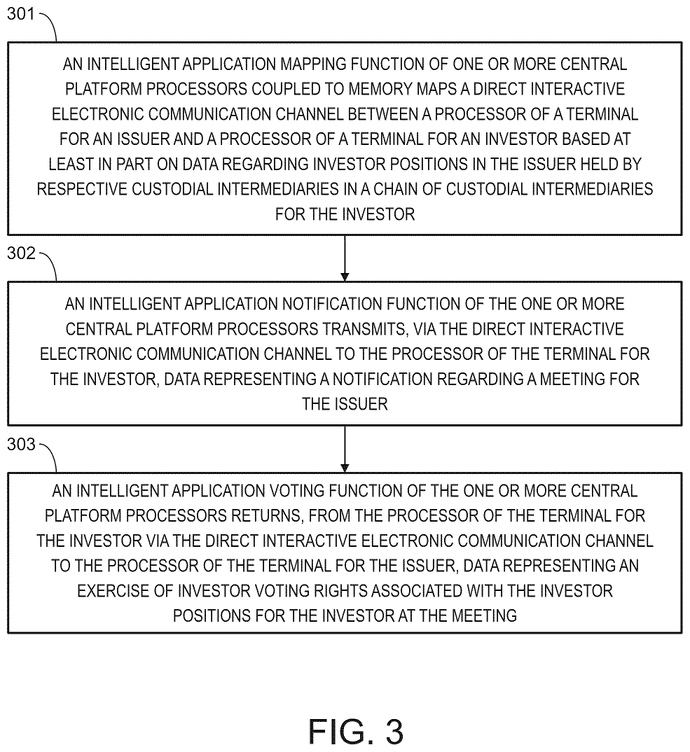

FIG. 3 is a flow chart that illustrates an example of a process of mapping and performing direct interactive electronic communication of proxy voting-related data for embodiments of the invention. Referring to FIG. 3, at 301, an intelligent application mapping function of one or more central platform processors coupled to memory maps a direct interactive electronic communication channel between a processor of a terminal for an issuer and a processor of a terminal for an investor based at least in part on data regarding investor positions in the issuer held by respective custodial intermediaries in a chain of custodial intermediaries for the investor, as will be described in greater detail below.

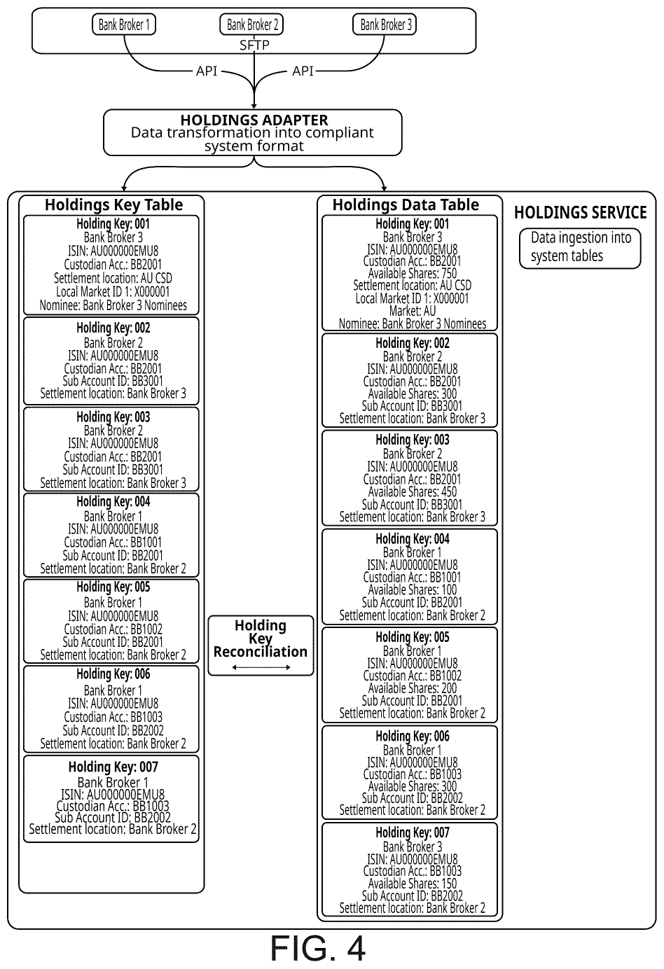

Referring now to FIG. 4, beneficial ownership of securities may be cerified by reconciling holdings data across a chain of custogy inovling muliptle intermediary custodians. The system provides issuers with real-time, certified visibility into the beneficial owners of securities through structured processing and hierarchical mapping of holdings information.

In an example, the system receives holdings data and associated account information from multiple bank brokers and intermediary custodians. The received data includes information representing investor positions in an issuer's securities as recorded at each level of the custodial chain. Upon receipt, the system transforms the data into a standardized internal format compatible with the processing architecture, ensuring consistent data interpretation across varied reporting sources.

The transformed data is ingested into a centralized holdings service, wherein the system structures the data into two primary relational tables. A first table, referred to as the holdings key table, generates and stores unique identifiers corresponding to each reported account, incorporating relevant metadata, including settlement location information. A second table, referred to as the holdings data table, records individual holding details, including account identifiers and available share quantities, and references the corresponding entry in the holdings key table. Each holdings data record thereby maintains an explicit association with its account and settlement metadata through the linked holding key.

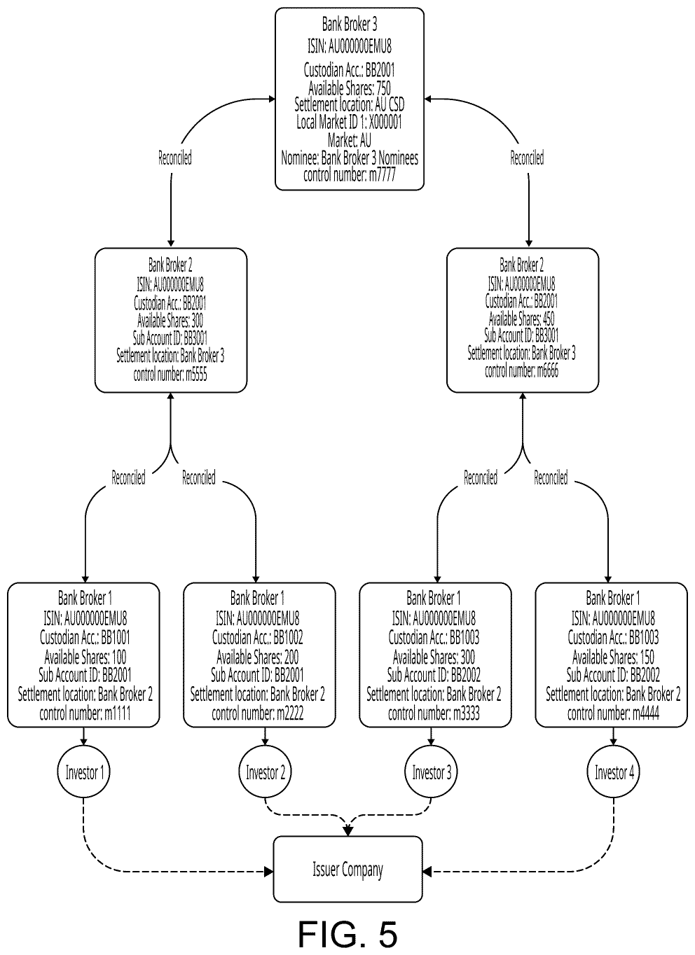

Referring now to FIG. 5, following ingestion and structuring, the system constructs a hierarchical representation of the custody chain based on the received holdings data. Each holding is linked to its immediate upstream position, building a chain of relationships through intermediary custodians. The hierarchy accommodates multiple descendant holdings mapping to a single ancestor holding, and supports an unlimited number of intermediary layers, thus facilitating the modeling of complex global custody environments.

Subsequently, for each reconciled holding, the system generates an entitlement object in a separate ballots table. Each ballot is associated with a holding and is linked to ancestor and descendant ballots within the hierarchy. As used herein, the term “ballot” encompasses any certified representation of entitlement, and is not limited to voting purposes.

The ballots corresponding to final descendant holdings are made available to the end investors. These ballots reflect reconciled and certified share positions, validated across the full chain of custodial intermediaries. As a result, issuers obtain verified exposure to final beneficial owners who were previously inaccessible due to intermediary layers.

The system further provides issuers with real-time certification of investor holdings, enabling secure and dynamic confirmation of beneficial ownership across continuously updated custodial structures. By structuring holdings data into a traceable, reconciled, and hierarchical format, the invention maintains data integrity, accommodates infinite levels of custodial reporting, and delivers immediate, verifiable ownership data to authorized parties.

Thus, as described above, the technology described herein enables the transformation, reconciliation, certification, and hierarchical mapping of securities holdings data across custodial intermediaries to provide issuers and authorized entities with dynamic and certified visibility into underlying beneficial owners.

Referring further to FIG. 3, at 302, an intelligent application notification function of the one or more central platform processors transmits, via the direct interactive electronic communication channel to the processor of the terminal for the investor, data representing a notification regarding a meeting for the issuer. At 303, an intelligent application voting function of the one or more central platform processors returns, from the processor of the terminal for the investor via the direct interactive electronic communication channel to the processor of the terminal for the issuer, data representing an exercise of investor voting rights associated with the investor positions for the investor at the meeting. In addition, the intelligent application voting function of the one or more central platform processors may also transmit, via the direct interactive electronic communication channel to the processor of the terminal for the at least one investor, data representing confirmation of the exercise of said investor voting rights.

While FIG. 3 presents a simple example involving a single investor, it is to be understood that, as illustrated in FIG. 1 and the schematic diagram of FIGS. 2A and 2B, embodiments of the invention may involve mapping direct interactive electronic communication channels between a processor of a terminal for an issuer or issuer agent and processors of terminals for any number of investors or investor agents based, for example, on data regarding investor positions in the issuer held by respective custodial intermediaries in respective chains of custodial intermediaries for each of the investors. Thereafter, notification data may be similarly transmitted to each investor via the respective direct interactive electronic communication channels, and data representing exercises of voting rights of respective investors may be returned to the issuer via the respective direct interactive electronic communication channels.

The platform application running on one or more processors of a host server for embodiments of the invention may be a web-based platform that users are able to access based on permissioning. Thus, when an entity becomes a client of the platform the entity may be given permission to access the web-based platform and enabled to see data which is applicable to the particular client-entity.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The present invention may be a system, a method, and/or a computer program product at any possible technical detail level of integration. The computer program product may include a computer readable storage medium (or media) having computer readable program instructions thereon for causing a processor to carry out aspects of the present invention.

It is to be understood that embodiments of the invention may be implemented as processes of a computer program product, each process of which is operable on one or more processors either alone on a single physical platform or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media may include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer- readable media to transmit or carry instructions to a computer, including a router, private or public network, or other transmission device or channel, both wired or wireless. Such instructions may comprise code from any suitable computer programming language including, without limitation, C, C++, C #, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices.

Aspects of the present invention may be described herein with reference to flowchart illustrations and/or block diagrams of methods, apparatus (systems), and computer program products according to embodiments of the invention. It will be understood that each block of such flowchart illustrations and/or block diagrams, and combinations of blocks in the flowchart illustrations and/or block diagrams, may be implemented by computer readable program instructions. These computer readable program instructions may be provided to a processor of a special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer- implemented process, such that the instructions which execute on the computer, other programmable apparatus, or other device implement the functions/acts specified in the flowchart and/or block diagram block or blocks.

The schematic diagrams in the drawings may illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the drawings hereto. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system to provide direct interactive electronic communications of proxy voting- related data between issuers and investors, comprising:
one or more central platform processors coupled to memory that is configured to:
receive uploads of data directed to investor positions from each respective custodial intermediary that is one of a plurality of custodial intermediaries that are contractually situated between at least one issuer and at least one investor;
identify a match between the at least one issuer and the at least one investor having a position in the at least one issuer based on the received data;
identify a plurality of custodial intermediaries between the at least one investor and the at least one issuer, wherein the identification of the match and the identification of the plurality of custodial intermediaries are performed on a daily basis;
map a direct interactive electronic communication channel between a processor of a terminal for the at least one issuer and a processor of a terminal for the at least one investor based at least in part on data regarding investor positions in the at least one issuer held by the identified plurality of custodial intermediaries;
transmit, in real time via the direct interactive electronic communication channel to the processor of the terminal for the at least one investor-without interpretation from the at least one custodial intermediary, a notification requesting an exercise of voting rights for the at least one issuer; and
return, from the processor of the terminal for the at least one investor via the direct interactive electronic communication channel to a processor of a terminal for the at least one issuer, an exercise of investor voting rights associated with said investor positions for the at least one investor at the meeting.

2. The system of claim 1, wherein the one or more central platform processors receives the data regarding investor positions in said at least one issuer held by said respective custodial intermediaries in the chain of custodial intermediaries for the at the least one investor from processors of terminals of the respective custodial intermediaries.

3. The system of claim 1, wherein said data regarding investor positions in said at least one issuer held by the respective custodial intermediaries in the chain of custodial intermediaries for the at the least one investor further comprises data regarding linkages between the respective custodial intermediaries.

4. The system of claim 1, wherein the one or more central platform processors recognizes said investor voting rights associated with the investor positions in the at least one issuer based at least in part on said data regarding investor positions held by said respective custodial intermediaries.

5. The system of claim 1, wherein said respective custodial intermediaries holding said investor positions in the at least one issuer on behalf of the investor comprise at least one of a global custodial entity, a sub-custodial entity, a wealth manager entity, and a private bank entity.

6. The system of claim 1, further comprising updating at least one custodial intermediary that is one of the plurality of custodial intermediaries that are contractually situated between the at least one issuer and the at least one investor based on received data.

7. The system of claim 1, wherein the one or more central platform processors transmits, via the direct interactive electronic communication channel to the processor of the terminal for the at least one investor, data representing said investor voting rights associated with said investor positions in the at least one issuer exercisable at the meeting.

8. The system of claim 7, wherein the one or more central platform processors recognizes said investor voting rights associated with said investor positions in the at least one issuer.

9. The system of claim 1, wherein the one or more central platform processors transmits, via the direct interactive electronic communication channel to the processor of the terminal for the at least one investor, the data representing the notification regarding the meeting for the at least one issuer in real time responsive to an upload of information regarding the meeting.

10. The system of claim 1, wherein the one or more central platform processors transmits, via the direct interactive electronic communication channel to the processor of the terminal for the at least one investor, the data representing the notification regarding the meeting for the at least one issuer without interpretation by any of said respective custodial intermediaries.

11. The system of claim 1, wherein the one or more central platform processors transmits, via the direct interactive electronic communication channel to the processor of the terminal for the at least one investor, the data representing the notification regarding the meeting for the at least one issuer a predetermined number days before a date scheduled for the meeting.

12. The system of claim 1, wherein the one or more central platform processors transmits, via the direct interactive electronic communication channel to a processor of a terminal of a vote advisory agent for the investor.

13. The system of claim 1, further comprising transmitting, via the direct interactive electronic communication channel to the processor, items slated for voting, market cut-off for voting, and number of exercisable investor voting rights.

14. The system of claim 1, wherein the one or more central platform processors transmits, via the direct interactive electronic communication channel to the processor of the terminal for the at least one investor, data representing post-meeting confirmation of the exercise of said investor voting rights.

15. The system of claim 1, wherein said one or more central platform processors comprise one or more web-based central platform processors.

16. The system of claim 1, wherein said one or more central platform processors comprise one or more web-based central platform processors accessible only by authorized users.

17. A method to provide direct interactive electronic communications of proxy voting- related data between issuers and investors, comprising:
receiving, by an intelligent application mapping function of one or more central platform processors coupled to memory, uploads of data directed to investor positions from each respective custodial intermediary that is one of a plurality of custodial intermediaries that are contractually situated between at least one issuer to at least one investor;
identifying, by the intelligent application mapping function of one or more central platform processors coupled to memory, a match of at least one investor having a position in at least one issuer and at least one custodial intermediary between the at least one investor and the at least one issuer based on the received data, wherein the identification is performed on a configured periodic basis;
mapping a direct interactive electronic communication channel between a processor of a terminal for the at least one issuer and a processor of a terminal for the at least one investor based at least in part on data regarding investor positions in the at least one issuer held by the identified plurality of custodial intermediaries;
transmitting, by the intelligent application notification function of the one or more central platform processors, via the direct interactive electronic communication channel to the processor of the terminal for the at least one investor-without interpretation from the at least one custodial intermediary, data representing a notification regarding a meeting for the at least one issuer; and
returning, by the intelligent application voting function of the one or more central platform processors, from the processor of the terminal for the at least one investor via the direct interactive electronic communication channel to the processor of the terminal for the at least one issuer, an exercise of investor voting rights associated with said investor positions for the at least one investor at the meeting.

18. The of method of claim 17, further comprising transmitting, by the intelligent application voting function of the one or more central platform processors, via the direct interactive electronic communication channel to the processor of the terminal for the at least one investor, data representing post-meeting confirmation of the exercise of said investor voting rights.
